(19) United States
(12) Patent Application Publication
(10) Pub. No.: US 2018/0310742 A1
(43) Pub. Date: Nov. 1, 2018

(54) COMBINATION COASTER AND WIPER DEVICE AND METHOD OF OPERATION

(71) Applicant: Joseph Cupp, St. Petersburg, FL (US)

(72) Inventor: Joseph Cupp, St. Petersburg, FL (US)

(21) Appl. No.: 15/581,887

(22) Filed: Apr. 28, 2017

(51) Int. Cl. A47G 23/03; A47L 13/17; A47K 7/03; B08B 1/00; B60S 1/64; A47L 1/15

(52) U.S. Cl. CPC A47G 23/03; A47L 13/17; A47L 1/15; B08B 1/006; B60S 1/64; A47K 7/03

(57) ABSTRACT

A combination coaster and wiper device and method of operation provides a generally flat disc serves as both a coaster for supporting a drinking vessel, and a wiper for wiping debris from a surface. The device is fabricated from a heat transfer vinyl material. In other embodiments, the disc may be fabricated from a kalle material and recycled materials; and in other embodiments, about 80% pig intestine, about 20% cellulose, and miscellaneous recycled materials. The device is manufactured in three different diameters. In the operational use as a coaster, the device rests under a drinking vessel containing a beverage, absorbing condensate material. In the operational use as a wiper, the device is configured to have sufficient absorbency to wipe off the surface of a surface, such as interior of a vehicle. Each color of the device corresponds to a different surface for wiping to prevent cross contamination.

### FIELD OF THE INVENTION

The present invention relates generally to a combination coaster and wiper device and method of operation. More so, the present invention relates to a coaster and wiper device having a generally flat disc that serves as both a coaster for supporting a drinking vessel containing a beverage, and a wiper for wiping off a surface, such as an interior vehicle surface; whereby the device is fabricated from a heat transfer vinyl material, or a kalle material and recycled materials, and in one embodiment, about 80% pig intestine, about 20% cellulose, and miscellaneous recycled materials; whereby the device is manufactured in 3 circular diameters; whereby in the operational use as a coaster, the device rests under a drinking vessel containing a beverage; whereby in the operational use as a wiper, the device is configured to have sufficient absorbency to wipe off the surface of a surface, including: an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin; whereby each color can represent a surface for wiping, so as to prevent cross contamination.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

It is known in the art that when placing a glass containing a potable liquid such as beer, soft drinks and cold water on a table, the table is often soiled by dew drops formed on the glass surface or the potable liquid split out of the glass. Therefore, in order to prevent a table from being soiled, a glass is often placed on a table by the medium of a coaster.

Typically, coasters are manufactured by using paper materials having a superior water absorption, and many of them have pictures, letters, graphics or the like printed on the surface by using inks which do not discolor to improve the colorful appearance.

Generally, a heat transfer vinyl is a specialty vinyl that can be used on certain fabrics and materials to create designs and promotional products. Heat transfer vinyl is often arranged in a roll or sheet form with an adhesive backing so it can be cut, weeded, and placed on a substrate for heat application.

It is known in the art that kalle sponge cloths are manufactured from cellulose and cotton fibers, both of which are renewable resources. Combining these natural products produces a unique sponge cloth with exceptional absorbency, durability and sustainability. The sponge cloths are also easy to dispose of as they are fully compostable and biodegradable.

Other proposals have involved coasters that support glasses. The problem with these coasters is that they do not serve the dual purpose of wiping off surfaces. Also, the logos and colors are not very dynamic or market driven. Even though the above cited coasters meets some of the needs of the market, a hose gripping apparatus that wraps around a combination coaster and wiper device and method of operation having a generally flat disc that serves as both a coaster for supporting a drinking vessel containing a beverage, and a wiper for wiping off a surface, such as an interior vehicle surface is still desired.

### SUMMARY

Illustrative embodiments of the disclosure are generally directed to a combination coaster and wiper device and method of operation. The coaster and wiper device is defined by a generally flat disc that serves as both a coaster for supporting a drinking vessel containing a beverage, and a wiper for wiping off a surface.

In one embodiment, the disc is fabricated from a heat vinyl material that has an adhesive backing. The heat vinyl material is efficacious for printing colors, logos, and patterns on the disc. Though in other embodiments, the disc may be fabricated with a kalle material and recycled materials, so as to enable absorption of moisture.

The disc may be manufactured in three circular diameters: small 2.75″, medium 3.0″, and large 3.45″. The disc may be defined by at least ten primary colors, including blue, green, yellow, and pink. Though additional colors and patterns may be manufactured. The disc can also be customized with a logo.

In operational use of the device as a coaster, the disc rests under a load, such as a drinking vessel containing a beverage. The unique kalle material of the disc directs condensate away from a drinking vessel, preventing fluid buildup on the drinking vessel, and further absorbs excess moisture that condenses from the side of the drinking vessel.

In operational use of the device as a wiper, the disc is configured to have sufficient absorbency to wipe off the surface of an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin. Each uniquely color can represent a surface for wiping, so as to prevent cross contamination. The disc is grasped and rubbed against the surface until the debris is removed. A cleaning composition may be used with the disc to enhance the cleaning effect. The method of manufacture may include punching out circular shapes form a panel of kalle material.

In one aspect, a combination coaster and wiper device, comprises:

providing a plurality of discs, the plurality of discs defined by an upper face, a lower face, and a perimeter region, the plurality of discs comprising a heat transfer vinyl material, or a kalle material, or both;

applying heat, an image, and color on the upper face, or the lower face, or both;

transferring ink, the image, and color to the upper face, or the lower face, or both;

placing the disc on a surface, such that the lower face engages the surface;

resting a drinking vessel on the upper face of the disc;

absorbing moisture, by the disc, from the drinking vessel; and

rubbing the lower face of the disc against the surface, whereby debris is removed from the surface.

In another aspect, the plurality of discs comprise about 80% pig intestine, about 20% cellulose, and miscellaneous recycled materials.

In another aspect, different diameters comprises 2.75 inches, 3 inches, and 3.45 inches.

In yet another aspect, the unique color, or pattern, or logo, or image, or combinations thereof includes at least ten colors or patterns, including at least one of the following: blue, green, yellow, and pink.

In yet another aspect, the load is a drinking vessel containing a liquid and forming a condensate moisture on an outer surface.

In yet another aspect, the surface includes at least one of the following: an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin.

One objective of the present invention is to provide a disc that is fabricated from kalle material and recyclable materials that work to absorb condensate moisture from a drinking vessel, and wipe a surface.

Another objective is to provide a disc having sufficient resiliency to support a load, such as a drinking vessel.

Yet another objective is to a disc that can be folded while wiping a surface.

Yet another objective is to provide multiple colors for each disc to correlate to a surface for wiping.

Yet another objective is to provide multiple diameter sizes of discs to accommodate differently sized drinking vessels.

Yet another objective is to provide an inexpensive to manufacture combination coaster and wiper device.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary combination coaster and wiper device, showing the upper face, in accordance with an embodiment of the present invention;

FIG. 2 illustrates a perspective view of the combination coaster and wiper device, showing the lower face, in accordance with an embodiment of the present invention;

FIG. 3 illustrates a perspective view of the combination coaster and wiper device acting as a coaster while supporting a drinking vessel having moisture condensate, in accordance with an embodiment of the present invention;

FIG. 4 illustrates a perspective view of the combination coaster and wiper device acting as a wiper on a vent surface, in accordance with an embodiment of the present invention;

FIG. 5 illustrates a perspective view of the combination coaster and wiper device acting as a wiper on a rearview mirror surface, in accordance with an embodiment of the present invention;

FIG. 6 illustrates a perspective view of the combination coaster and wiper device acting as a wiper on a glass surface, in accordance with an embodiment of the present invention; and

FIG. 7 illustrates a flowchart of an exemplary method for operation of a combination coaster and wiper device, in accordance with an embodiment of the present invention.

Like reference numerals refer to like parts throughout the various views of the drawings.

### DETAILED DESCRIPTION OF THE INVENTION

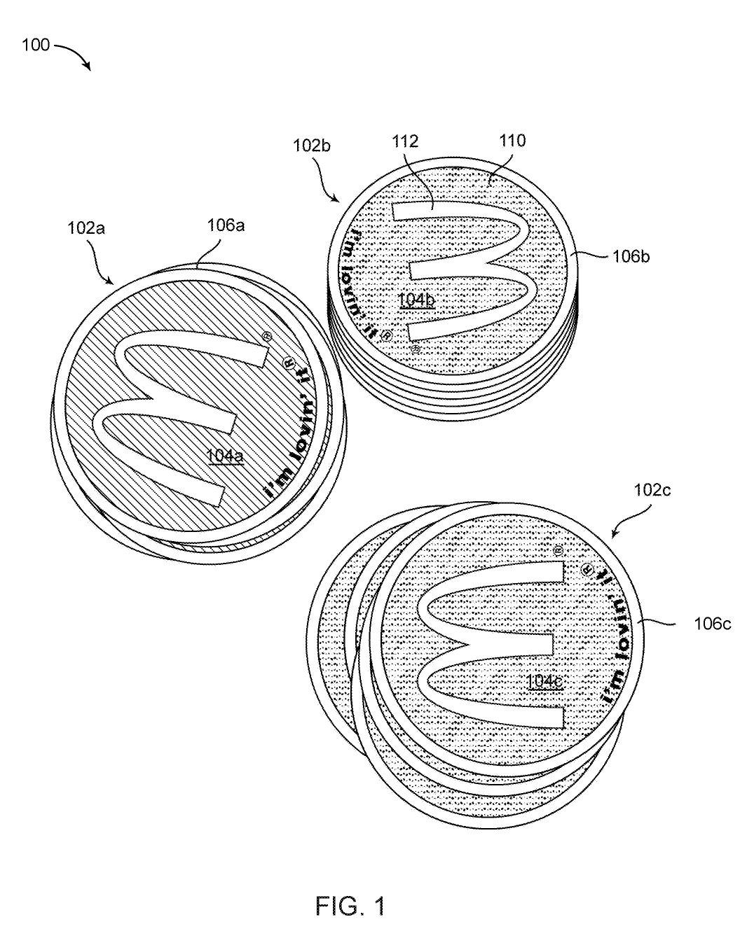

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A combination coaster and wiper device 100 and method of operation is referenced in FIGS. 1-7. The coaster and wiper device 100, hereafter “device 100” provides a generally flat disc 102a-c that serves as both a coaster for supporting a drinking vessel 300, and a wiper for wiping debris from at least one surface 304a-c.

In one embodiment, disc 102a is fabricated from a heat transfer vinyl material. In other embodiments, the disc 102b may be fabricated from a kalle material and recycled materials; and in other embodiments, disc 102c comprises about 80% pig intestine, about 20% cellulose, and miscellaneous recycled materials.

As referenced in FIG. 1, device 100 is manufactured in three different diameters, so as to accommodate variously sized drinking vessels 300 and surfaces 304a-c. In the operational use as a coaster, the device 100 rests under a drinking vessel 300 containing a beverage, while absorbing moisture 302—often as condensate. In the operational use as a wiper, the device 100 is configured to have sufficient absorbency and grit to wipe off the surface 304a-c, such as interior of a vehicle vent 304a, rear view mirror 304b, and window 304c. Each color 110 of the device 100 corresponds to a different surface for wiping. This color coordinated arrangement helps to prevent cross contamination.

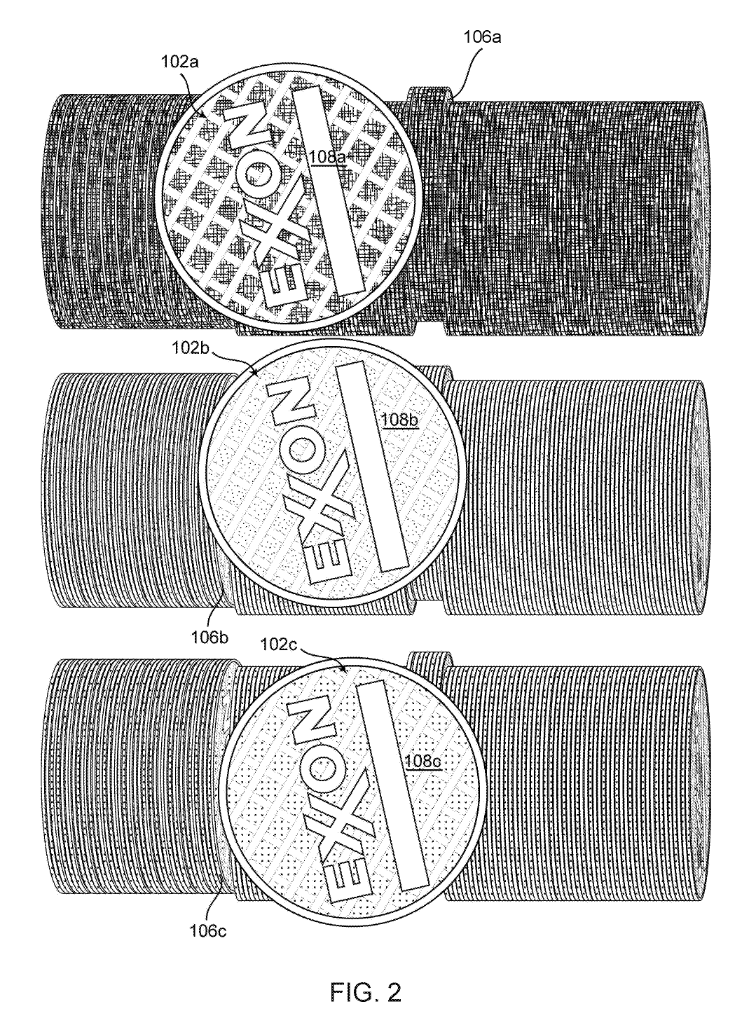

Turning now to FIG. 2, a color 110, image 112, logo, and pattern may be printed on either face 104a-c, 108a-c of the disc 102a-c, so as to monetize the device 100. When manufactured substantially with heat vinyl transfer material, then an image 112 and color 110 may be applied with heat to adhere the color 110 and image 112 on the upper face 104a-c, or the lower face 108a-c, or both. When manufactured substantially with kalle material, then an ink, the image 112, and the color 110 are transferred to the upper face 104a-c, or the lower face 108a-c, or both.

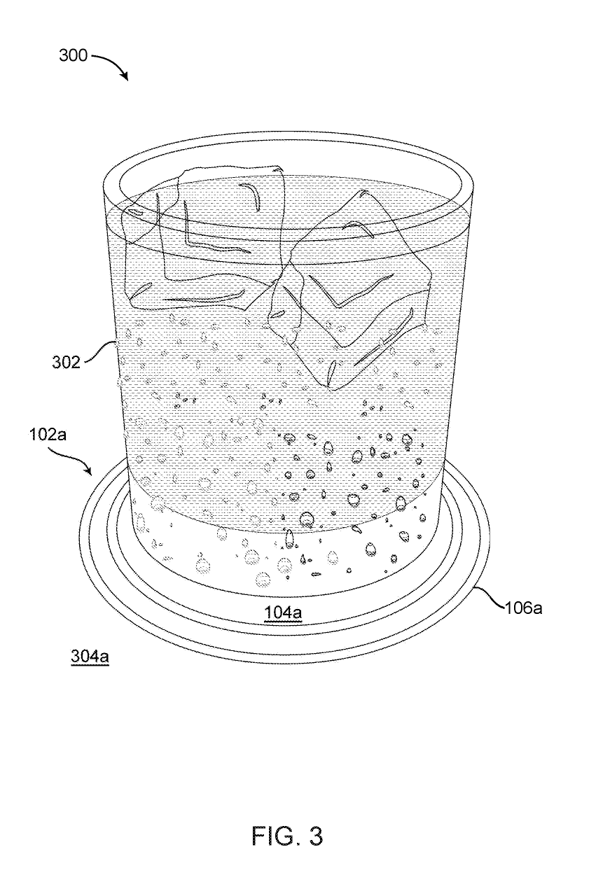

As referenced in FIG. 1, disc 102a-c is defined by an upper face 104a, 104b, 104c, a lower face 108a, 108b, 108c, and a perimeter region 106a, 106b, 106c. Upper face 104a-c is generally oriented upwardly to support drinking vessel 300. As FIG. 3 illustrates, disc 102a-c is sufficiently rigid and durable to support a load, such as a drinking vessel 300. Lower face 108a-c is oriented against surface 304a-c while supporting the drinking vessel 300. Lower face 108a-c has sufficient grit or adhesive characteristics to effectively wipe off surface 304a-c. Perimeter region 106a-c forms a circumference that encircles the upper and lower face 104a-c, 108a-c.

In one embodiment, disc 102a-c is fabricated from a heat vinyl material that has an adhesive backing. The heat vinyl material is efficacious for printing color 110, images 112, logos, and patterns on upper and lower faces 104a-c, 108a-c of disc 102a-c. Though in other embodiments, disc 102a-c may be fabricated with a kalle material and recycled materials, so as to enable absorption of moisture.

In yet another embodiment, disc 102a-c is fabricated with a combination of the heat vinyl material and the kalle material. In yet another embodiment, disc 102a-c comprises about 80% pig intestine, about 20% cellulose, and miscellaneous recycled materials. In general, when a clearer image or color is desired, the heat vinyl material is preferred. When a more absorbent material is desired, the kalle material is preferred.

Those skilled in the art will recognize that kalle sponge cloths have been manufactured from cellulose and cotton fibers, both of which are renewable resources. Combining these natural products produces a unique sponge cloth with exceptional absorbency, durability and sustainability. It is also known that kalle cloth has been used primarily in the hotel industry as a cleaning product.

Thus, the capacity of disc 102a-c to absorb the moisture is important for supporting the drinking vessel 300, since condensate moisture 302 may roll of the outer surface of the drinking vessel 300 onto the upper face 104a-c of the disc 102a-c. In this manner, the absorbent material composition of the disc 102a-c prevents this condensate from building up on the surface.

In addition to being manufactured from kalle, a more specific material composition of the disc 102a-c may include about 80% pig intestine, 20% cellulose, and miscellaneous recycled materials. In this embodiment, the cellulose is the kalle equivalent. Though in other embodiments, different proportions of material may be used.

In one alternative embodiment, the disc 102a-c may be fabricated from Kalle Cloth and viscose. The Kalle Cloth is made from recycled materials and use a screen printing method. The viscose is a Shammy (not made from recycled materials) and uses heat-applied vinyl. In this embodiment, the Kalle can only have 1 color logo, while the viscose can have multi-color logos.

Furthermore, disc 102a-c may be manufactured in at least three circular diameters: small 2.75″, medium 3.0″, and large 3.45″. Each size diameter of the disc 102a-c is unique to supporting a differently sized drinking vessel 300. The thickness of the perimeter region 106a-c of disc 102a-c varies according to the requirements of the coaster and wiper. However, in other embodiments, additional diameter and thickness dimensions may be used.

In addition to different sizes, each disc 102a-c is defined by a unique color 110, or pattern, or logo, or image 112, or combinations thereof. In one embodiment, disc 102a-c may be defined by at least ten primary colors, including blue, green, yellow, and pink. Though additional color 110s and patterns may be manufactured. The disc 102a-c can also be customized with a logo, so as to monetize the device 100.

In one alternative embodiment, there are three sizes and ten colors to choose from. Salespeople, Coaster Pro on the Go Is great for repeat and referral business and getting people to remember a business or organization. In one operational use, a thank you note could be placed on the surface of the disc 102a-c, for either considering doing business with you or for Doing, business with you. Ordering is made generally easy; whereby a consumer could enter a website, such as www.CoasterProOnTheGo.com. Possible, prices may range from $2.99 for a two pack to $9.99 for a 12 pack. Furthermore, customized bulk discs start at 0.83 each for 125 custom discs. The more you order, the more you will save. Stop & Go, pick up your Coaster Pro, on the go.

In operational use of the device 100 as a coaster, the disc 102a-c rests between a surface and a drinking vessel 300 containing a beverage. Disc 102a-c serves to protect the surface 304a-c from scratching or chipping by the drinking vessel 300, and also absorbs moisture condensate form the outer sidewall of the drinking vessel 300.

Those skilled in the art will recognize that liquid drinking vessels have a tendency to form moisture condensate on their outer surface. The unique kalle material of the disc 102a-c directs condensate away from the outer surface of the drinking vessel, preventing fluid buildup on the drinking vessel, and further absorbing excess moisture that condenses from the side of the drinking vessel. The thickness of the disc 102a-c is directly proportional to the amount of moisture that can be absorbed.

In operational use of the device 100 as a wiper, the disc 102a-c is configured to have sufficient absorbency and surface area to efficiently wipe off a plurality of surfaces 304a-c. Specifically, the lower face 108a-c of disc 102a-c is efficacious for removing debris from surfaces 304a-c commonly used in the interior of a vehicle. In one embodiment, the surface is in the interior of a vehicle.

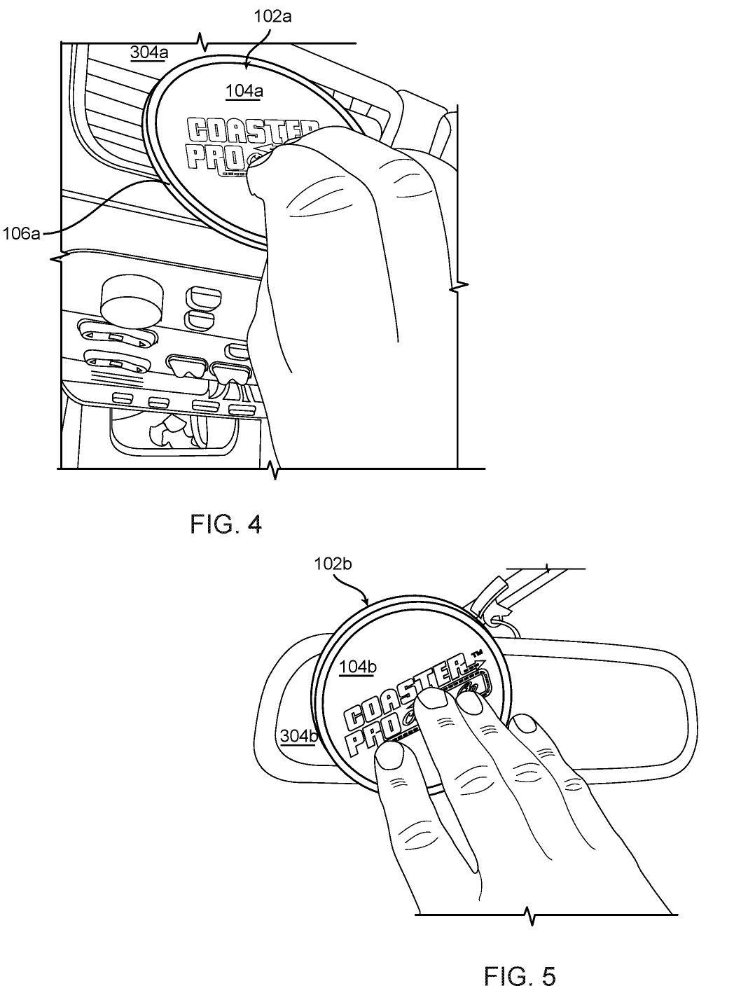

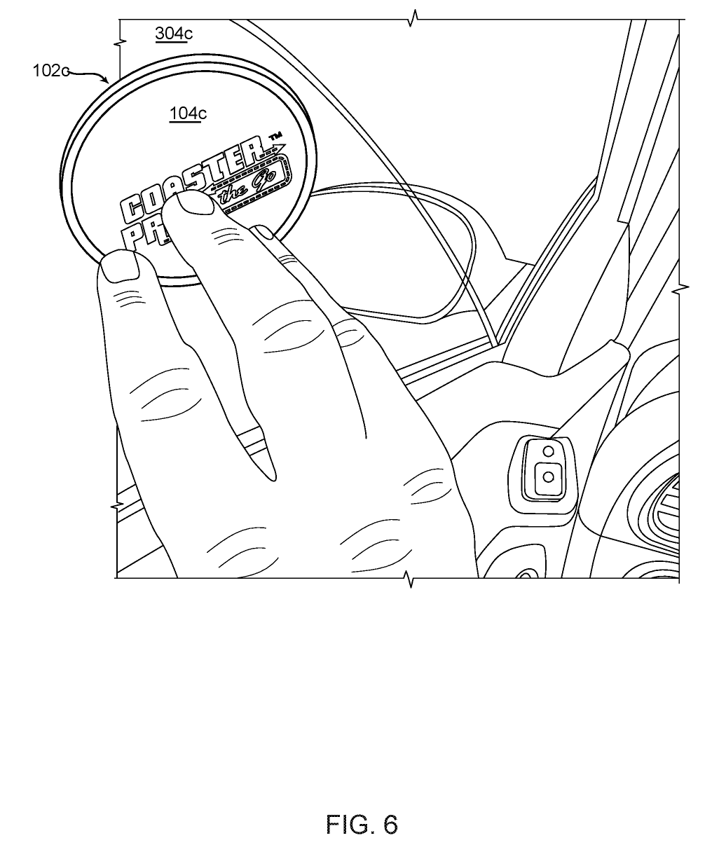

FIG. 4 shows disc 102a engaging a vent surface 304a. FIG. 5 shows disc 102b engaging a rearview mirror surface 304b. FIG. 6 shows disc 102c wiping a vehicle window surface 304c. In each case, a hand grasps upper face 104a-c and perimeter region 106a-c of disc 102a-c, while rubbing lower face 108a-c against surfaces 304a-c. Additional surfaces that may be wiped may include, without limitation, a dashboard, a steering wheel, a medium density fiberboard panel, a fiberglass panel, and a polyvinylchloride panel. A cleaning composition may be applied to lower face 108a-c to enhance the wiping process.

Each uniquely colored disc 102a-c correlates to a surface for wiping. This color coded arrangement helps prevent cross contamination between different surfaces. For example, a blue disc may be used for wiping glass or rearview mirror surface, while a red disc wipes dashboard surfaces.

In one exemplary embodiment, the device 100 supports a drinking vessel 300 in a cup holder of a vehicle, and wipes off the various interior surfaces 304a-c of the vehicle. Though, in other embodiments, the device 100 may be used in other environments to support a different load and wipe debris from different, non-vehicle surfaces, such as walls, kitchen sinks, bathroom appliances, and skin.

In use, the disc 102a-c is grasped and rubbed against the surface 304-c until the debris is removed. A cleaning composition may be used with the disc 102a-c to enhance the cleaning effect. A method of manufacture may include punching out circular shapes form a panel of kalle material.

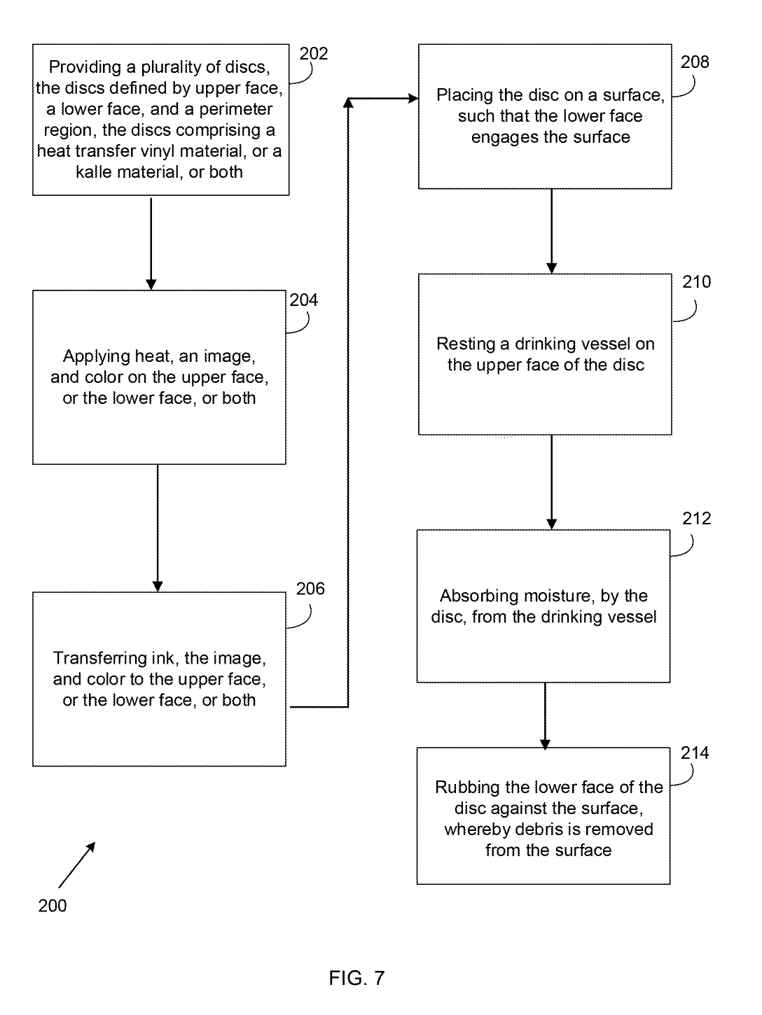

FIG. 7 illustrates a flowchart diagram of an exemplary method 200 of operation for a combination coaster and wiper device 100. In some embodiments, method 200 may provide a combination coaster and wiper device and method of operation. More so, the present invention relates to a coaster and wiper device having a generally flat disc that serves as both a coaster for supporting a drinking vessel containing a beverage, and a wiper for wiping off a surface, such as an interior vehicle surface.

Method 200 may include an initial Step 202 of providing a plurality of discs, the plurality of discs defined by an upper face 104a-c, a lower face 108a-c, and a perimeter region, the plurality of discs comprising a heat transfer vinyl material, or a kalle material, or both. Method 200 may further comprise a Step 204 of applying heat, an image 112, and color 110 on the upper face 104a-c, or the lower face 108a-c, or both. This printing process is effective when disc 102a is substantially fabricated from heat vinyl transfer material.

In some embodiments, a Step 206 includes transferring ink, the image 112, and color 110 to the upper face 104a-c, or the lower face 108a-c, or both. This printing process is effective when disc 102b is substantially fabricated from kalle, or cellulose material. A Step 208 comprises placing the disc 102a-c on a surface, such that the lower face 108a-c engages the surface. In essence, disc 102a-c serves as a coaster in this disposition.

In some embodiments, a Step 210 includes resting a drinking vessel 300 on the upper face 104a-c of the disc 102a-c. Drinking vessel may include a glass containing a beverage that is a different temperature than the ambient air; thereby creating condensation moisture on an outer sidewall of glass.

A Step 212 may include absorbing moisture, by the disc 102a-c, from the drinking vessel. The capacity of disc 102a-c to absorb the moisture is important for supporting the drinking vessel 300, since condensate moisture 302 may roll of the outer surface of the drinking vessel 300 onto the upper face 104a-c of the disc 102a-c. Both the heat vinyl transfer material and the kalle are effective for absorbing moisture 302.

A final Step 214 comprises rubbing the lower face 108a-c of the disc 102a-c against the surface, whereby debris is removed from the surface. The lower face 108a-c is configured to be sufficiently abrasive, so as to remove debris from various types of surfaces 304a-c, and especially interior surfaces of a vehicle. In operation, a hand grasps upper face 104a-c and perimeter region 106a-c of disc 102a-c, while rubbing lower face 108a-c against surfaces 304a-c. A cleaning composition may be applied to lower face 108a-c to enhance the wiping process.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A combination coaster and wiper device, the device comprising:
a plurality of generally flat, circular discs, the plurality of discs defined by an upper face, a lower face, and a perimeter region, the plurality of discs comprising a heat transfer vinyl material, the plurality of discs configured to enable support of a load, the plurality of discs further configured to absorb moisture, the plurality of discs further configured to remove debris from a plurality of surfaces, the plurality of discs defined by different diameters, each disc defined by a unique color, or pattern, or logo, or image,
whereby the plurality of discs absorb moisture,
whereby the unique color of each disc helps identify a corresponding surface to remove debris.

2. The device of claim 1, further comprising a kalle material mixed with the heat transfer vinyl material.

3. The device of claim 2, further comprising about 80% pig intestine, about 20% cellulose, and miscellaneous recycled materials mixed with the heat transfer vinyl material and the kalle material.

4. The device of claim 1, wherein the different diameters comprises at least one of the following: 2.75 inches, 3 inches, and 3.45 inches.

5. The device of claim 1, wherein the unique color, or pattern, or logo, or image includes at least one of the following: blue, green, yellow, and pink.

6. The device of claim 1, wherein the load is a drinking vessel containing a liquid and forming a condensate moisture on an outer surface.

7. The device of claim 1, wherein the surface includes at least one of the following: an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin.

8. A combination coaster and wiper device, the device comprising:
a plurality of generally flat, circular discs, the plurality of discs defined by an upper face, a lower face, and a perimeter region, the plurality of discs comprising a kalle material and a recycled material, the plurality of discs configured to enable support of a load, the plurality of discs further configured to absorb moisture, the plurality of discs further configured to remove debris from a plurality of surfaces, the plurality of discs defined by different diameters, each disc defined by a unique color, or pattern, or logo, or image,
whereby the color includes at least one of the following: blue, green, yellow, and pink,
whereby the different diameters comprises at least one of the following: 2.75 inches, 3 inches, and 3.45 inches,
whereby the plurality of discs absorb moisture forming on the load,
whereby the unique color of each disc helps identify a corresponding surface to remove debris.

9. The device of claim 8, further comprising a heat vinyl transfer material mixed with the kalle material.

10. The device of claim 9, further comprising about 80% pig intestine, about 20% cellulose, and miscellaneous recycled materials mixed with the heat transfer vinyl material and the kalle material.

11. The device of claim 8, wherein the load is a drinking vessel containing a liquid and forming a condensate moisture on an outer surface.

12. The device of claim 8, wherein the surface includes at least one of the following: an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin.

13. A method of operation of a combination coaster and wiper device, the method comprising:
providing a plurality of discs, the plurality of discs defined by an upper face, a lower face, and a perimeter region, the plurality of discs comprising a heat transfer vinyl material, or a kalle material, or both;
applying heat, an image, and color on the upper face, or the lower face, or both;
transferring ink, the image, and color to the upper face, or the lower face, or both;
placing the disc on a surface, such that the lower face engages the surface;
resting a drinking vessel on the upper face of the disc;
absorbing moisture, by the disc, from the drinking vessel; and
rubbing the lower face of the disc against the surface, whereby debris is removed from the surface.

14. The method of claim 13, wherein about 80% pig intestine, about 20% cellulose, and miscellaneous recycled materials are mixed with the heat transfer vinyl material, or the kalle material, or both.

15. The method of claim 13, wherein the load is a drinking vessel containing a liquid and forming a condensate moisture on an outer surface.

16. The method of claim 13, wherein the surface includes at least one of the following: an interior surface of a vehicle, a window, a dashboard, a vent, a steering wheel, a medium density fiberboard panel, a fiberglass panel, a polyvinylchloride panel, a sink, a kitchen surface, a wall, a furniture, a floor, and skin.
